(19) United States
(12) Patent Application Publication
(10) Pub. No.: US 2022/0063019 A1
(43) Pub. Date: Mar. 3, 2022

(54) IMPROVEMENTS IN THE WELDING OF PIPES

(71) Applicant: SAIPEM S.P.A., Milan (IT)

(72) Inventors: Giorgio STEFANO, Milan (IT); Davide ROSSIN, Milan (IT)

(73) Assignee: SAIPEM S.P.A., Milan (IT)

(21) Appl. No.: 17/422,914

(22) PCT Filed: Jan. 10, 2020
(86) PCT No.: PCT/EP2020/050589

§ 371 Date: Jul. 14, 2021

(30) Foreign Application Priority Data
Jan. 15, 2019 (GB) 1900568.5

(51) Int. Cl. B23K 26/211; B23K 26/282; B23K 26/342

(52) U.S. Cl. CPC B23K 26/211; B23K 2101/06; B23K 26/342; B23K 26/282

(57) ABSTRACT

A first metal pipe is welded to a second metal pipe in a method of laying pipeline, for example from a pipe-laying vessel at sea. The metal pipes may have an outer diameter greater than 150 mm and a pipe wall thickness of greater than 15 mm. The first pipe and the second pipe are brought together prior to welding so as to sandwich a third type of metal material between the pipe ends. The thickness of the third type of material, immediately before welding may be between 0.05 mm and 2 mm. The third metal material is melted together with the metal material of the first pipe and the second pipe.

### FIELD OF THE INVENTION

The present invention concerns methods and apparatuses relating to pipe welding. More particularly, but not exclusively, this invention concerns the welding of pipes end-to-end, with a high energy welding apparatus, which induces high temperatures in the weld material and consequent rapid cooling in the weld joint and/or surrounding material, yet produces high quality welds for pipes that are suitable for use for conveying oil and/or gas.

### BACKGROUND OF THE INVENTION

Pipelines for the transportation of oil and gas must often be laid in water, for example at sea. Typically, when laying a pipeline at sea, one end of the pipeline (sometimes referred to as the string) is held by a pipeline laying vessel and a section of pipe is welded onto the end of the pipeline, at a location on the vessel commonly referred to as the firing line. In the oil and gas services industry, one of the main costs of any project is the time spent at sea. One of the main rate limiting steps, determining how long the pipe laying vessel must remain at sea, is the process of forming the pipeline in the firing line as described above. There is therefore a desire to increase the speed at which pipeline is laid.

However, quality is also key. Welded joints between sections of pipe in the pipeline must be of high quality. Ensuring extremely high weld quality and confidence in that quality is of the utmost importance when laying gas/oil pipeline at sea in circumstances when the pipeline will be under very high tension and/or will be subject to significant fatigue loading when being laid and/or when operational. Ensuring extremely high quality and confidence is also important when laying pipeline that will carry any highly corrosive substances in operation, such as so-called “sour” services. Sour services are typically carried by clad pipes (which may for example include a corrosion resistant inner lining) and/or pipes comprising CRA alloys (Corrosion Resistant Alloys)

In the field of application of the welding of a fixed length of pipe, the traditional type of welding process are: electric arc welding with filler material, Gas Metal Arc Welding (GMAW), Submerged Arc Welding (SAW), Flux Cored Arc Welding (FCAW), Shielded Metal Arc Welding (SMAW), or Gas Tungsten Arc Welding (GTAW), in which the two ends that are joined have chamfer edges (also called bevel edges) the function of which is to accommodate the metallic filler (molten metal) in the form of molten bath (pool).

The bath melts and solidifies along with the adjacent portion of pipeline through a series of weld beads that are wrapped around the circumference of the pipe. For example in GMAW technology the weld material is a continuous wire that acts as the first electrode to generate an electric arc with the base of the chamfer (which acts as second electrode) in this way the wire is unwound and melted continuously.

In GMAW technology the wire comes out continuously from a torch (welding gun) from which comes out that acts as a first electrode to generate an electric arc with the base of the chamfer (acting as a second electrode). In this way, a wire is unwound and melted continuously. Whilst the wire comes out continuously from the torch (welding gun), additionally a gas is released that settles on and protects the bath from adverse processes as oxidation.

Whilst GMAW technology is well understood and produces high quality weld joins, one of its main disadvantages is that several welding passes are required in order to maintain form a joint of a thick section of pipe.

In light of these disadvantages, in many heavy industries, research and development is focused substituting their conventional welding methods with high energy welding technologies, such as laser welding. However, in such applications that require thick-section welding, challenges remain yet in developing high energy welding techniques to compete with conventional welding methods.

The disadvantages of high energy welding technologies (such as laser welding or electron beam welding) include the safety associated with the high energy beam, and the need to control any plasma effects which occur during the welding process.

Such plasma effects may be undercut (a groove melted into the base metal adjacent to the weld toe or weld root and left unfilled by weld metal) or underfill (a condition in which the weld face or root surface extends below the adjacent surface of the base metal) of the weld joint.

There is some known prior art in the mitigation of the plasma effects of high-energy welding technologies. In Japanese patent application JP5724294, by JFE steel Corp., the plasma effects of the laser beam are controlled by the movement of the laser spot, the de-powering and defocusing of the laser beam, and the use of a specific angle of incidence of the laser beam on the joint surface. However, this prior art, whilst disclosing a method which may improve the quality of the weld join, has also disclosed something which adds complexity and possibly a longer time on the weld firing line. This piece of prior art may reduce the penetration depth of the welding source, reducing the thickness of the pipes which may be welded with this technology, a major disadvantage.

A typical problem of laser welding is of metallurgical type and it is caused by the high cooling rate of the material involved in the welding. This can cause defects in the welded material: the laser brings heat on a low volume of material with a high thermal power in a very short period of time. The resultant high cooling rates can form hard structures such as martensite on the carbon steels normally used in offshore pipeline manufacture. Consequently, unwanted mechanical characteristics, such as low toughness and resilience and/or surface defects can form. High cooling rates can also induce adverse grain growth paths during solidification process often resulting in solidification defects or other defects that are formed when the material is at a high temperature and then rapidly cools. The formation of such hot cracks, or solidification cracks, is a common issue in high energy welding followed by rapid cooling of the metal, once the heating energy is removed.

United States patent application US2005155960 describes a hybrid welding process employing a laser beam combined with an electric arc, with a supply of consumable welding wire and shielding gas, in which the said wire is melted by the said laser beam and/or the said electric arc so as to produce a weld on at least one steel work piece to be welded. However, this piece of prior art has clear disadvantage, in that the consumable wire used can only penetrate so far into the thickness of the pipe, putting an upper limit in the thickness of the pipes that this can be used on at under 10 mm in thickness.

International patent application WO2015039154 proposes a welding system in which a ring of predefined chemical form and composition is inserted between the two pipes to assist the laser welding methodology. An issue with using prefabricated rings is that there are many different combinations of pipe joint during assembly and misalignment between the parts to be joined, which make it impracticable have a consumable ring available for every possible joint. Ensuring a good and accurate fit between each pipe end face and opposing side of the prefabricated ring is another potential disadvantage of this proposed solution.

International patent application WO2017140805 (Saipem) describes a welding process with pre-heating by inductors that is applied on coupled joints in the presence of gap. This solution is particularly advantageous on thick pipes (20-30 mm) where the induction leads to a uniform temperature profile on the thickness and reduces the cooling speed. This piece of prior art also discloses the use of a spacer, which improves the coupling precision, and can provide additional material that forms part of the weld.

The present invention seeks to mitigate one or more of the above-mentioned problems. Alternatively or additionally, the present invention seeks to provide an improved pipe welding method.

### SUMMARY OF THE INVENTION

In accordance with a first aspect of the present invention there is provided a method of joining a first workpiece to a second workpiece, the method comprising bringing the workpieces together with a layer of material positioned therebetween, thus forming a joint to be welded and then welding the workpieces together, at least part of (preferably all of) the intermediate layer of material melting in the process, thus forming a joint between the two pipes. In an embodiment of the invention, the first and second workpieces are pipes, the layer of material is deposited on at least one of the pipe ends before the welding step, the layer of material is of a different type of material from that of either pipe, and the welding is in the form of a keyhole laser welding process that melts not only the layer(s) of material between the pipes but also at least part of each pipe end. It may be that the welding process is performed in a way that requires no extra filler material to be added in order to form a satisfactory weld (i.e. not filler material in addition to the layer(s) of material between the pipe ends). Such an embodiment provides a very efficient and speedy method of joining a pipe to another pipe, for example in a method of laying pipeline from a vessel at sea. The layer of material may deform when the workpieces are brought together to provide a distribution of material across the opposing faces of the workpieces that better fills any cavities/gaps between the workpieces before welding is commenced.

As acknowledged above, certain embodiments of the invention relate to welding pipes together. In accordance with a second aspect of the present invention there is provided a method of welding a first pipe and a second pipe end-to-end, comprising a step of bringing the end face of the first pipe and the end face of the second pipe together with an intermediate layer of material positioned between the end faces of the pipes, thus forming a joint to be welded. The first pipe is made from a first metal material and the second pipe is made of a second metal material, which may be the same type of material. There is a subsequent step of providing heating energy to the joint to be welded, for example with one or more welding torches, so that at least part of the intermediate layer of material melts. The heating energy is subsequently removed, and then the heated material solidifies, so that a joint is made between the two pipes.

The intermediate layer of material may be made from a third metal material. The third metal material may have a different chemical composition from the first material and/or from the second material. The intermediate material may be provided in the form of more than one layer. For example, one layer may be associated with, for example deposited on, the end face of the first pipe and another layer may be associated with, for example deposited on, the end face of the second pipe. The intermediate material may be a steel alloy. The steel alloy may comprise less than 90% weight Iron, optionally less than 80% weight Iron. The intermediate material may be an alloy comprising more than 30% weight Iron. The intermediate material may have an alloy composition wherein at least 95% by weight (preferably at least 98%, and optionally at least 99%) is provided by only one or only two, or optionally only three, elements. In one embodiment of the invention, the intermediate layer of material used may be entirely elemental nickel (e.g. being at least 99% pure nickel). In some embodiments of the invention, it may be a nickel alloy containing above 50% by weight Nickel. In another embodiment of the invention, the material used may be a steel and/or iron alloy containing greater than 2% by weight Nickel, for example greater than 5% or greater than 10% by weight, and possibly greater than 20% by weight Nickel (for example Invar, being ˜36% nickel and ˜64% iron). The intermediate layer of material may also be a steel alloy containing greater than 0.5% silicon. This intermediate layer of material may be a member of the family of alloys ER80SNi. As a specific example of this family of alloys, the intermediate layer of material may be the alloy ER80SNi-2. ER80SNi-2 as a class of material as defined by the American Welding Society (AWS). Typically such materials may contain between 2 and 2.75% nickel by weight, and between 0.4-0.8% silicon by weight.

In other embodiments of the invention, the intermediate layer of material may be of a composition so that, after the welding is complete, the composition of the weld joint may be similar to that of ER80SNi-2. The inclusion of nickel can advantageously prevent the adverse grain growth paths, and inferior metallic structures, such as martensite, which can form because of high cooling rates. This is because nickel acts as a grain-refiner and promotes acicular ferrite formation which can be beneficial to weld toughness.

The intermediate layer of material may be in the form of material which has been deposited on at least one of the end faces of the pipes. It may be that the material is deposited on at least one of the end faces of the pipes before bringing the end faces of the pipes together, and possibly before the method of the invention is performed. For example, the intermediate layer of material may be deposited on the end faces of the pipes by a different entity from the entity that performs the method and/or in a different territory.

The material may be deposited to form a thin coating of material on the workpiece/pipe. For example, the material deposited may have a typical thickness of 10s of microns (e.g. 20 to 90 microns). The thickness of the layer of material on the end face of one of the pipes may be less than 100 microns. The coating may have a typical thickness of up to 10s of millimetres (e.g. 20 to 90 millimetres). The average thickness of the layer of material on the end face of one of the pipes (taken as an average over the area of the end face on which the layer is present) may be less than 50 microns, for example 40 microns or lower. In embodiments, the thickness is preferred to be 30 microns or more and/or 100 microns or less. Different embodiments of the invention may utilise different means of depositing such coatings. Such methods may be physical, chemical or hybrid in nature. The material may for example be deposited by any of sputtering, buttering, dipping, plating, spraying, and/or additive manufacturing techniques such as laser metal deposition and electron beam melting deposition. In some embodiments, there may be different discrete areas (or regions) of material deposited on the end face of a pipe, possibly such that the material deposited in one discrete area (or region) is different (in terms of its chemical composition) from the material deposited in a different discrete area (or region) on the same pipe end.

It may be the case in some embodiments of the invention that the joint that is made between the two pipes comprises a weld seam, which has a thickness that is greater than the thickness of the intermediate layer of material. The weld seam thickness is defined by those regions that have melted during the welding process, and therefore form some of the weld joint. The weld seam will typically be surrounded by a heat affected zone (HAZ), that being the regions of material, which have not melted but which have been otherwise affected by the welding heat (for example, material which has had its microstructure altered by the welding heat). For the purposes of measuring the thickness of a weld seam, which has different thickness at different locations, it may be that the thickness is defined as the average thickness of the weld joint in the axial direction taken over the whole depth of the weld joint and around the entire circumference of the pipe. The thickness of the intermediate layer of material (with which the weld seam thickness is compared) may be defined as the average thickness of the layer extending from the pipe end face in the axial direction, as measured immediately before welding (e.g. after fit-up, during which in certain embodiments the intermediate layer of material may be compressed and therefore possibly made thinner).

The step of providing heating energy to the joint to be welded may cause all (or substantially all) of the intermediate layer of material to melt. The step of providing heating energy to the joint to be welded may cause at least part of the first metal material of the first pipe, and/or at least part of the second metal material of the second pipe, to melt. It may be that at least part of the first metal material of the first pipe melts and mixes with some of the intermediate layer of material. It may be that at least part of the second metal material of the second pipe melts and mixes with some of the intermediate layer of material.

In some embodiments of the invention, the step of providing the heating energy may cause at least part of the first material to melt and cause at least part of the second material to melt. The first and/or second material may for example melt together with the intermediate layer of material. It is advantageous that all three materials melt, for example mixing to some degree, as this may result in a stronger weld joint than if only one or two of the three materials melt on application of said heating energy.

There may be a step of deforming the intermediate layer of material. In some embodiments of the invention, it may be the case that the step of bringing the end of the first pipe and second pipe together causes the intermediate layer of material to deform.

It may be the case that the deformation of the intermediate layer of material reduces the effects of misalignment, in the radial direction, between two corresponding positions on two adjacent pipe end-faces. For example, it may be that the intermediate layer of material deforms in the region of a misalignment and when welded acts to better smooth over the misalignment than would otherwise be the case. It may do this by filling in the space either above or below the ends of the pipes to be joined. This may assist in forming a good weld when the pipes are slightly misaligned, for example when the maximum “hi-lo” around the circumference of the pipes is higher than might otherwise be deemed as non-negligible.

It could also or alternatively be the case that the deformation of the intermediate layer of material reduces misalignment, in the axial direction, between two corresponding coupling edge surfaces of two adjacent pipe end-faces. For example, it may be that the intermediate layer of material deforms in the region of a gap between the pipe ends, for example fill, at least partially, the gap that would otherwise exist, and thus improve the weld quality. There may be local imperfections in the pipe ends that mean that the two end faces do not abut perfectly over the entire area of the end faces. There may be regions where the separation of the opposing surfaces (or the “gap”) is higher than might otherwise be deemed as non-negligible, so that cavities exist between the opposing surfaces. The deformation of the intermediate layer of material may result in more material filling, or partially filling, such cavities, thus reducing the misalignment, in the axial direction, between the pipe end-faces.

In some embodiments of the invention, the intermediate layer of material may have a hardness and/or stiffness that is lower than that of the first metal material and that is lower than that of the second metal material. It may be that the hardness and/or stiffness of the third type of material is lower than the 25% of the hardness and/or stiffness of the pipe material. The hardness and/or stiffness of the third type of material may be at least one order of magnitude lower than the hardness and/or stiffness of the pipe material (e.g. lower than ˜10%). This may be advantageous in some embodiments, as it could allow for significant deformation of the intermediate layer of material at a lower force than that required to deform either of the first or second pipes. This may allow the intermediate layer to deform significantly, and thus be better distributed over the pipe ends, without the first and second materials deforming as the ends of the pipes are brought together. This may enable for misalignment in the pipes to be mitigated or effectively corrected, as described above, without introducing additional misalignment through deformation of the pipe ends. It may be that the intermediate layer has a yield point which is lower than that of the material used to construct the pipes (e.g. the first and/or second materials). It may be that the fracture toughness of the intermediate material is lower than that of the pipe material.

In some embodiments of the invention, the intermediate layer of material may have a hardness and/or stiffness that is not lower than (and optionally is higher than) that of the first metal material and/or the second metal material. It may be that the hardness and/or stiffness of the third type of material is higher than 125% of the hardness and/or stiffness of the pipe material. There may be a step of deforming the first and/or second material. In some embodiments of the invention, it may be the case that the step of bringing the end of the first pipe and second pipe together causes the intermediate layer of material to cause deformation of the first and/or second material.

In some embodiments of the invention, the bringing of the end face of the first pipe and the end face of the second pipe together and the making of the joint between the two pipes occur at a single welding workstation. Performing all pipe alignment and welding steps at a single welding workstation allows for efficient usage of space on the vessel, for embodiments where the welding occurs at sea, and may also increase efficiency in other ways. For example, performing all of the principal welding steps at a single welding workstation may reduce complexity on the firing line and may also increase productivity. It may also reduce the amount of equipment that is required on a pipe laying vessel.

The making of the joint between the two pipes may occur in a single welding pass. The making of the joint between the two pipes may occur without using a rod of filler material, filler wire, or the like. The making of the joint between the two pipes may occur without using any extra filler material, over that provided by the intermediate layer(s).

Some embodiments of the invention are particularly well suited to the use of high energy welding techniques. The step of providing heating energy to the joint to be welded may be performed by keyhole welding, for example with a high energy welding device. The high energy welding device may be a laser welding device in some embodiments of the invention. In others, it may be an electron beam welding device. The welding device may use an electric arc. The high energy welding device may be a plasma welding device. The high energy welding device may comprise one or more welding torches. For example, the high energy welding device may be a laser welding device comprising one or more welding torches. It will be understood that when employing a keyhole welding technique, a concentrated heat source penetrates deep within a work-piece, possibly through substantially the entire thickness of the work-piece, forming a hole at the leading edge of the molten weld metal at the surface of the workpiece to which the heat source is applied. As the heat source progresses, the molten metal fills in behind the hole to form the weld bead. This may be advantageous as a welding technique as it can produce narrow welds, with deep penetration and low distortion effects. The use of such highly focused high energy welding devices can cause extremely high temperature gradients in the region of the weld and the surrounding material, and consequent rapid cooling rates after the source of the heating energy is removed. However, certain embodiments of the present invention are well suited to such techniques, with the use of one or more evenly distributed intermediate layers of material that can be engineered to mitigate against the disadvantageous effects of rapid cooling.

In some embodiments of the invention, the keyhole welding is performed with a laser with a spot size of less than 0.5 mm. This is advantageous as a small spot size allows energy to be transferred quickly and efficiently, resulting in a shorter time required to complete a weld. In other embodiments of the invention, the spot diameter may be less than 1,000 μm. The spot diameter may be more than 100 μm. In these or other embodiments, a fibre optic cable may deliver the laser beam. This may be mounted on automated, or semi-automated, robotic equipment, which minimises the potential hazards of human exposure to a high energy source. It may be that the power density of the energy source is greater than 10 kW/mm² at the surface of the workpieces. It may be that the power density of the energy source is greater than 50 kW/mm², for example around 70 kW/mm² or higher. This has the advantage that the keyhole welding of the workpieces can occur at pace and at a stable rate.

In some embodiments of the first or second aspects of invention, welding is performed with a welding device which forms a weld in one-pass having a depth of more than half the thickness of the pipes, preferably more than 75% of the thickness. It may be that such one-pass welding causes at least part of the third metal material to melt together with the first metal material and/or at least part of the third metal material to melt together with the second metal material. It may be the case, for some embodiments of the invention, that the depth of welding achieved is greater than 10 mm. In these or other embodiments of the invention, the depth of welding achieved may be higher, and be greater than 20 mm. A deep weld may be advantageous as it means that the weld covers a higher proportion of the faces of the welded pipes, forming a stronger join.

It may be that the weld is performed on only one side of the pipe (for example from outside of the pipes—i.e. welding from the exterior rather from inside the pipes). For example, in some embodiments, a welding device forms a weld in one-pass which extends through substantially the entire thickness of the workpieces (additionally or alternatively, at least 90% of the thickness). This may result in a quicker speed of welding, as many current production lines require pipes to be welded on two sides in order to form a weld joint with sufficient strength and/or use multi-pass welding techniques where successive layers of welding material are laid down in a welding groove. Various embodiments of the invention have the advantage however of improving the speed at which the welding can take place on the firing line, by the use of such one-pass full depth welding. It may be that the welding occurs only on the exterior side of the pipe. This may simplify the design of a firing line in comparison to current technologies, for example by reducing the number of robotic weld jigs required and/or avoiding the need for internal welding equipment for welding from inside the pipes. In certain embodiments of the invention, welding may occur from both sides (interior and exterior) of the pipe.

In certain embodiments of the invention, welding may be performed with multiple welding heads, for example each welding head working on a different sector of the pipe circumference. Multiple welding heads may perform welding at the same time. Each welding head may comprise one or more welding torches. In certain embodiments of the invention, welding may be performed with multiple welding torches, for example the multiple welding torches performing welding at the same time.

After the end face of the first pipe and the end face of the second pipe have been brought together and immediately before commencement of the step of providing heating energy to the joint to be welded, the material positioned between the end faces of the pipes may have an average thickness along the axial direction of the pipe of greater than 0.05 mm, preferably greater than 0.1 mm, and optionally greater than 0.2 mm. It may be that the average thickness is less than 2 mm, for example the thickness may be 1 mm or less (optionally less than 0.1 mm). In some embodiments of the invention, it may be advantageous to have a material thickness which is neither too thin nor too thick. A preferred range in certain embodiments is between 0.05 mm and 1 mm (another preferred range being between 0.02 mm and 0.1 mm), as this may result in the weld seam containing both the intermediate layer of material and the base material of the pipe. As described elsewhere herein, this may allow for the altering of the chemical properties of the pipe in a way which makes the join stronger and less susceptible to solidification cracking. Additionally, a thickness of between 0.05 mm and 1 mm or between 0.02 mm and 0.1 mm may allow for a fast deposition of the third material on the base material of the pipe ends, which may allow for strong bonding of the material to the base material, as compared to the case when a thicker layer is used.

In other embodiments, the layer of material positioned between the end faces of the pipes may be thicker than mentioned above. The material may have a thickness (as measured along the axial direction of the pipe) greater than 1 mm, and possibly greater than 2 mm. It may be that the material is up to 5 mm thick. The advantage of this is that the deposited material would make up a higher percentage of the weld seam in this case, and so the properties would mirror that of the deposited material more, which may for example be resistant to solidification cracking. Additionally, in embodiments of the invention which exploit the deformability of the deposited material to reduce the gaps between ends of pipes, it may be that a thicker layer of deposited material means that larger gaps and misalignments can be accommodated for.

The end face of a pipe typically has an annular shape. The overall shape of the intermediate layer of material between the end faces of the pipes preferably corresponds to that of the end face of the pipe. Thus, the shape of the intermediate layer of material may be generally annular corresponding to that, both in shape and size for example, of the annular cross-section of the pipes. The intermediate layer of material between the end faces of the pipes may be sized and shaped to extend over the entirety of the annular end face of at least one of the pipes. It may be that no part (e.g. no non-negligible part) of the end face is left uncovered by the extent of the intermediate layer of material, once the pipes have been brought together. It may be that gaps that would exist between the pipes, if brought together without any intermediate layer(s) between, are filled at least partially during the bringing together of the pipes by such intermediate layer(s). Additionally or alternatively, it may be that such gaps are filled during the welding of the pipes, or otherwise do not exist after such welding.

The intermediate layer of material may have a shape having an outer diameter that is the same as the outer diameter of the pipes (for example within a margin of +/−1%). The intermediate layer of material may have a shape having an inner diameter that is the same as the inner diameter of the pipes (for example within a margin of +/−1%). The intermediate layer of material may cover the whole area of the face of the pipe end. Alternatively, the intermediate layer of material could be slightly bigger/smaller than the whole area of the face of the pipe end and yet still have an annular shape that is sized to broadly correspond to that of the end face of the pipe.

It may be that before the step of bringing the end faces of the pipes together, the intermediate layer of material extends over the end face of at least the first pipe so that it extends to cover at least part of the interior pipe surface and/or the exterior pipe surface of the first pipe. This may additionally be the case for the second pipe, or it may be only the second pipe where the intermediate layer of material extends over the end face of the pipe so that it extends to cover at least part of the interior pipe surface and/or the exterior pipe surface. Having an excess of intermediate layer of material in this way can be advantageous as, on melting, the intermediate layer of material may shrink in volume relative to the base material. Having an excess of the intermediate layer of material on the inside pipe surface and outside pipe surface as well as on the end of the face of the pipe means that the intermediate layer of material may still substantially cover the face of the end of the pipe even if shrinking occurs during the welding process.

In some embodiments of the invention, it may be the case that the step of bringing the end of the first pipe and second pipe together causes the intermediate layer of material to change shape by a process that involves deformation of at least part of the intermediate layer of material and/or fracture of at least part of the intermediate layer of material. It may be that the intermediate layer comprises multiple voids and/or pores, which collapse (wholly or partially) when the intermediate layer of material changes shape during the step of bringing the first pipe and second pipe together.

It may be that the layer comprises one or more structures, for example an array of multiple structures, for example columns, of material. The structures may extend from the end face of the first and/or the second pipe in a direction along the axis of the pipe. Such columns, or structures, may be sufficiently shaped (e.g. long and thin) that they deform significantly and/or fracture when the pipes are brought together. The greatest thickness of the intermediate layer of material before the pipes are brought together may reduce by at least 25%, possibly at least 50%, by means of the columns, or structures, deforming during the bringing of the pipes together. The columns, or structures, may be arranged in a dendritic structure. The columns, or structures, may be arranged in a reticular structure. The columns, or structures, may be arranged in a regular structure as regards their size, shape and/or spacing. The columns, or structures, may be irregularly arranged. The columns, or structures, need not have a constant cross-section, and need not extend exactly in a direction parallel to the pipe axis. The structures, which project outwards from the face of the pipe to which they are attached, on the bringing of two pipe ends together, may deform or break. This may help with ensuring that the intermediate layer of material substantially covers the end faces of the pipes prior to the start of welding. This may result in a stronger, more even join between the pipe ends. Each structure may have a volume of less than 10⁻⁸ m³. There may be more than 100, optionally more than 1,000, and possibly more than 5,000, separately discernible structures on the end of a pipe.

Voids and/or pores may be intentionally included in the intermediate layer material, for example in the structure of the intermediate layer material. The presence of voids and/or pores reduces the strength, hardness and/or stiffness of a bulk material for example by altering the macroscopic structure and therefore the macroscopic properties of the intermediate layer material. Therefore, it may be beneficial to include voids and/or pores in the microstructure of the intermediate layer material in order to facilitate a deformation of the intermediate layer at a lower force. Voids and/or pores may comprise at least 1% and optionally at least 5% of the sum volume of the intermediate layer of material (that sum volume including both the volume of the solid material and the volume of the gaps defined by the voids/pores). Voids and/or pores may comprise less than 50% of the sum volume of the intermediate layer of material in some aspects of the invention, optionally less than 20%, and possibly less than 10% of the sum volume of the intermediate layer of material. The intermediate layer may comprise a lattice structure, for example including such voids and/or pores. The intermediate layer may comprise a porous structure.

In cases where the weld seam thickness is greater than the thickness of the intermediate layer of material, the weld joint that forms as a result of the removal of the heating energy may contain both the base metal and the intermediate layer. The proportions in which the base metal and intermediate layer make up the weld joint may affect the joint composition.

In some embodiments of the invention, the composition of the intermediate layer may be tuned to account for mixing with the base metal on welding, so that the final composition of the weld seam is of a specific composition. In some embodiments of the invention, the resultant composition of the mixing may have a higher percentage by weight of nickel than at least one of the first material and the second material. The third material may (before mixing) may comprise more than 2% by weight nickel (optionally more than 5%). In some embodiments of the invention, the resultant composition of the mixing may be of greater than 1% by weight nickel, possibly greater than 2% by weight nickel. In some embodiments of the invention, the weld seam may have a final composition similar to that of ER80SNi-2 (say, within +/−10% of the amounts of any given constituent, on average). An advantage of tuning the properties of the weld seam in this way may be to improve resistance to solidification cracking, which (as mentioned above) can be an issue in welding if the cooling of the molten metal is too rapid. As mentioned previously, the inclusion of nickel can advantageously prevent or mitigate the adverse grain growth paths, and inferior metallic structures, such as martensite, which can form because of high cooling rates. Martensite is more brittle than austenitic steel, and has a much lower yield point. Reducing the likelihood of such structures from forming may therefore make a weld joint relatively stronger and more reliable.

In some embodiments of the invention, the first material and second material are the same composition. In other embodiments of the invention, the first and second material may be of different compositions, therefore may melt to differing extents. In some embodiments of the invention, the first and second material may be steel. It may be that the first and second material may be a steel of a quality grade of between X52 and X70. Here it should be noted that the steel quality grades as described in the form “Xn” where n is a number, are grades of pipe for the oil and gas industry, as regulated by API 5L, which adheres to the International Organization for Standardization ISO 3183. The ISO standard 3183 defines minimum mechanical properties for the steels used in the pipes. The number, n, denotes the minimum yield strength (being n multiplied by 1,000 pounds per square inch) of a pipe produced to this grade. The minimum yield strength for X52 pipes is 360 MPa, and the minimum tensile strength is 460 Mpa. For X70 pipes the minimum yield strength is 485 MPa and the minimum tensile strength is 570 MPa. The requirements of the chemical composition of the base material also changes according to the grade specified. For example, X52 pipe may have no greater than 0.26% by weight carbon, or 1.40% Manganese. X70 pipe on the other hand, whilst having the same maximum limit on carbon content, allows for a percentage of manganese of no greater than 1.80%, depending on the delivery condition of the pipe. In any embodiment of the invention described herein, it is to be appreciated that the use of such classifications of pipe are in reference to ISO standard 3183 as in force on 1 Oct. 2018.

In some embodiments of the invention, the first pipe and second pipe may be seamless. The first and second material may be steel of grade X60QO or better, that may have been quenched and tempered in order to improve its mechanical properties. In other embodiments of the invention, the first pipe and second pipe may be longitudinally welded. The first pipe and second pipe may be thermo-mechanically formed into shape. The first and second material may be of grade X60 MO or better.

The grade of steel used for first material and second material may be suitable for the type and pressure of the oil to be transported, and also the temperature of the environment in which the pipeline is to be laid. For example, the hardness of the pipes may be between 180HV10 to 300HV10 (as measured using a Vickers hardness test).

The intermediate layer of material may be at least partially made of manganese carbon steel. The intermediate layer of material may be an alloy having at least 10% manganese. The inclusion of manganese and/or manganese carbon steel may increase the weldability and strength of the join made between the intermediate layer of material and the first and second pipes as unlike carbon steel, manganese carbon steel softens rather than hardens when rapidly cooled, restoring the ductility from a work-hardened state. This reduces the chance of solidification cracking occurring in the welded joint.

The intermediate layer material may include alloying elements such as one or more, preferably three of more of, the group consisting of Manganese, Nickel, Chromium, Molybdenum, Copper, Boron, Titanium, Niobium, and Vanadium in order to improve the mechanical properties and corrosion resistance of the joint. The addition of Chromium may increase the toughness of steel, as well as the wear resistance. Another potentially beneficial effect of adding Chromium to the steel alloy is that it may impart resistance to staining and corrosion. Copper may also improve the corrosion resistance of the steel. Molybdenum may act to slow the critical quenching speed of the material, meaning the effects of rapid cooling are less negative on the intermediate layer of material. Niobium may act to control the grain structure of the steel. The addition of a very small percentage of Boron can be used to tune the hardenability of the steel, along with Titanium.

Embodiments of the invention may also include Aluminium or Silicon in the intermediate layer of material. These additions can act as deoxidising agents, which can remove oxygen from the melt during solidification of the intermediate layer. More or less aluminium or silicon can therefore be used in view of the volume percentage of pores or voids in the microstructure of the intermediate layer.

The intermediate layer material may have characteristics and/or a composition similar to the filler wire/properties thereof as referred to in the paper entitled “Hybrid welding possibilities of thick sections for arctic applications”, by Ivan Bunaziv et al (Physics Procedia 78-2015—pages 74 to 83), the contents of which being incorporated herein by reference thereto.

The material of the intermediate layer may be weldable grade steel, preferably low carbon weldable grade steel. The steel material may have a carbon content of less than 0.5% by weight, and possibly ˜0.4% or less. The material may have a low equivalent carbon content, for example a CE value of less than 0.5% and optionally ˜0.4% or less. The CE value may be calculated as the percentage by weight of carbon plus ⅙ of the combined Mn and Si content, plus ⅕ of the combined Cr, Mo and V content plus 1/15 of the combined Cu and Ni content.

In accordance with a third aspect of the invention, there is provided a method of pipe welding, the method comprising a step of moving the end face of a first metal pipe towards the end face of a second metal pipe so as to sandwich a third type of metal material therebetween, the third type of metal material being different in composition from the metal material of the first and second pipes. The method further includes a step of performing one-pass welding (preferably with a laser welding apparatus and/or preferably using a keyhole welding technique) to form a weld between the pipes so that at least part of the third metal material is melted together with the metal material of the first and/or second pipes. The one-pass welding step may form a weld between the pipes having a depth of more than 50% (preferably more than 75%) of the thickness of the pipes. The weld may extend throughout substantially the entire depth of the thickness of the pipes.

In accordance with a fourth aspect of the invention, there is provided a method of pipe welding comprising a step of moving the end face of a first pipe towards the end face of a second pipe so as to sandwich and deform a third type of metal material therebetween, and a step of welding the pipes together so that at least part of the third metal material is melted together with the metal material of the first and/or second pipes, the deforming of the third type of metal material lessening the effect of imperfections on each of the end faces of the pipes on the weld so formed. It may be that each of the end faces has imperfections (for example not being perfectly flat) that would otherwise result in cavities between the end faces if brought together, the third type of metal material deforming so as to lessen the effect of such cavities and/or filling at least partially such cavities and/or reducing the volume of all such cavities. It may be that the mass of the third type of metal material located in at least some of those cavities (preferably the majority, optionally substantially all, of those cavities) is greater, per unit area of the end face, than (for example more than 110% of) the average mass per unit area, of the third type of metal material, between the end faces. It may be that the deformation of the third type of metal material causes the volume of any cavities that remain after the pipes have been fully brought together (but before welding) to be less than 75% (for example less than 50%) of the volume of all the cavities that would otherwise result between the end faces when brought together (without the use of the third type of material). It will typically be the case that, absent the third type of material, if the pipe ends were urged together such cavities would exist between the opposing surfaces, but any given cavity may not be perfectly closed by the opposing surfaces of the pipes. When the gap between the pipe ends at any given point exceeds 100 μm it may be assumed that there is a cavity present. When the gap is less than, say 20 μm, the opposing surfaces may be assumed to be so close to each other as to be no different (or no worse aligned in the direction of the pipe axis) than if actually touching. A cavity between the pipe ends need not be closed on all sides. The deforming of the material to better fill gaps/cavities may accommodate misalignments of the two end pipe faces as described in relation to corresponding aspects of the first or second aspects of the invention.

In both the third and fourth aspects of the invention, at least part of the third metal material is melted together with the metal material of the first and/or second pipes. Thus, it may be that at least part of the third metal material is melted together with some of the metal material of the first pipe and at least part of the third metal material is melted together with some of the metal material of the second pipe. It may be that, during performance of the method, substantially all of the third metal material between the melted material of the pipes, is melted. Thus, it may be that the third metal material is entirely melted at least to the same depth (in the direction of the pipe wall thickness) as the melting of the metal material of the first and/or second pipes. It may be that, during performance of the method, all of the third metal material is melted. The method of the above-described aspects of the invention may be of particular application where the metal pipes have an outer diameter greater than 150 mm, possibly greater than 500 mm, and/or where the pipe wall has a thickness of greater than 10 mm. The pipe wall may have has a thickness of greater than 15 mm, optionally greater than 20 mm and possibly greater than 25 mm. The pipe wall may have a thickness of 50 mm or less (possibly less than 45 mm). It may be that the third type of metal material is deposited on at least one of the end faces of the first and second pipe. The average thickness of the third type of metal material, (a) once sandwiched between the pipes and/or (b) immediately before the welding step is performed, may be greater than 0.05 mm (possibly greater than 0.1 mm and optionally greater than 0.2 mm) and/or may be less than 5 mm (optionally less than 1 mm and possibly less than 0.1 mm). The welding may be performed without using extra filler wire, filler rods or other extra filler material (other than the layer(s) of material sandwiched between the pipes).

In some embodiments one or both end faces of the pipes may have been prepared in advance of performing the method, such that the end face comprises the intermediate layer of material. In other embodiments, the method may include a step of depositing the intermediate layer of material on at least one of the end faces of the pipes before the step of bringing the end faces of the pipes together. The intermediate layer of material may be deposited over the end face. The intermediate layer of material may be deposited over a part of the inside (interior) surface of the pipe in the region of the end face. The intermediate layer of material may be deposited over a part of the outside (exterior) surface of the pipe in the region of the end face. The step of depositing the intermediate layer of material on a pipe may include coating the material on the end of the pipe. The step of depositing the intermediate layer of material on a pipe may include spraying the material on the end of the pipe. The step of depositing the intermediate layer of material on a pipe may include dipping the end of the pipe in material. The deposition method may be a sputtering method. The intermediate layer of material may be applied at a thickness of between 0.1 mm and 1 mm on the end of the pipe (or possibly at a thickness of between 0.01 mm and 0.1 mm). The step of depositing the intermediate layer of material on a pipe may include using an additive manufacturing technique. It may be that the additive manufacturing technique used is laser or electron melting deposition. It may be that the additive manufacturing technique used is a laser metal deposition process. The use of an additive manufacturing technique may be particularly useful in creating the columns/structures of material on the end face of the pipe mentioned herein.

In some embodiments, the intermediate layer of material may be provided separately, as one or two (fewer than ten, at least) separate pieces for example. The intermediate layer of material may for example be in the form of, or comprise, a gasket.

Embodiments of the present invention have particular application when performed on a pipe-laying vessel at sea.

The present invention also provides a pipe with an integrated layer of material on at least one end face of the pipe, the pipe and integrated layer of material being configured for use in the method according to other aspects of the present invention.

According to the present invention, there is also provided a method of depositing material on the end of a pipe so as to form a pipe being configured for use in the method according to other aspects of the present invention. This aspect of the invention does not necessarily require the performance of the other steps of the first to third aspects of the invention mentioned herein. The material may be deposited by means of an additive manufacturing technique.

The present invention also provides a kit of parts for use in a method of laying a pipeline. The kit may comprise multiple pipes, each being a pipe being configured for use in the method according to other aspects of the present invention, and a welding apparatus (for example a laser welding apparatus). The kit may comprise multiple pipes, a welding apparatus (for example a laser welding apparatus) and apparatus for depositing material on the end of a pipe so as to form a pipe configured for use in the method according to the present invention. The kit of parts may be provided on a pipe-laying vessel.

It will of course be appreciated that features described in relation to one aspect of the present invention may be incorporated into other aspects of the present invention. For example, the method of the invention may incorporate any of the features described with reference to the apparatus of the invention and vice versa.

### DESCRIPTION OF THE DRAWINGS

Embodiments of the present invention will now be described by way of example only with reference to the accompanying schematic drawings of which:

FIG. 1 shows a side view of a pipeline laying vessel according to a first embodiment of the invention;

FIG. 2 shows a side view of two ends of pipe being welded together on the vessel of FIG. 1;

FIG. 3 shows part of the end of a pipe, which has been coated with filler material in accordance with the first embodiment;

FIG. 4 shows a partial cross-section of the end of the pipe shown in FIG. 3;

FIG. 5 shows the bringing of the pipes together according to the first embodiment;

FIGS. 6 to 8 are various cross-sections showing the ends of the pipes being brought together and illustrating typically axial and radial misalignments and how those are reduced by the first embodiment;

FIG. 9 shows the pipe joint once welded according to the first embodiment, the weld seam extending beyond the original extent of the filler material;

FIG. 10 shows a welded pipe joint once welded, the weld seam being narrow than the extent of the material sandwiched between the pipes;

FIG. 11 shows pipe being prepared by depositing filler material on the end of the pipe in accordance with a second embodiment,

FIG. 12 shows a partial cross-section of the end of the pipe shown in FIG. 11;

FIGS. 13 and 14 illustrate a method according to a third embodiment, in which material is deposited with the use of an additive manufacturing technique; and

FIG. 15 show a pipe welding method according to a fourth embodiment, in which filler material is supplied separately as a gasket.

### DETAILED DESCRIPTION

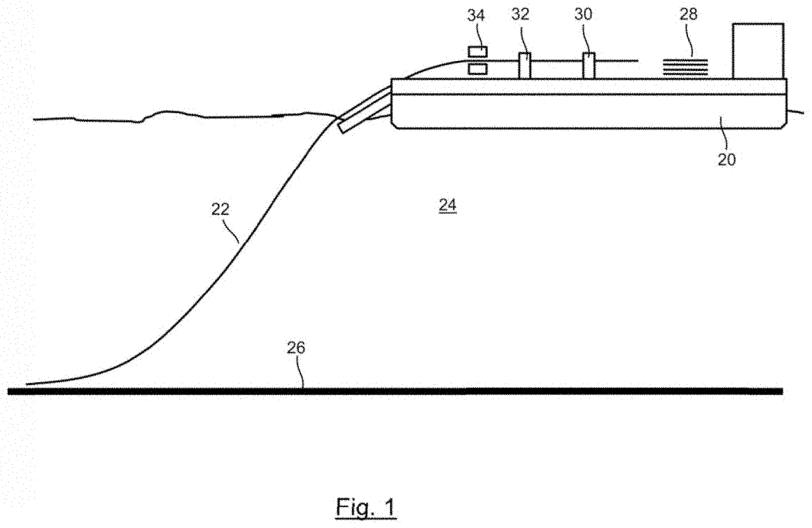

FIG. 1 shows a pipe laying vessel 20 laying a pipeline 22 in water 24 using an S-lay process. It will be seen that the pipeline 22 forms the general shape of an “S” as it is laid off the vessel 20 towards the seabed 26. The first embodiment concerns welding successive sections 28 of pipe to the end of the pipeline 22 as the pipeline is laid from the vessel 20.

The sections 28 of pipe added to the pipeline 22 (string) are each 12 m long (but could be multiples of 12 m in other embodiments, or any other length). Each pipe has an outer diameter of 1000 mm. The sections 28 of pipe (and the resulting pipeline) are steel pipes having a relatively low carbon content. The steel is low carbon weldable grade steel having a relatively low effective carbon content (CE).

The alloying composition of the steel pipe in this embodiment (as ascertained using the ASTM E415-17 “standard test method for analysis of carbon and low-alloy steel by spark atomic emission spectrometry” made available by ASTM International—www.astm.org) complies with the following limits: Fe ˜97.5%, C≤0.1%, Mn ≤1.40%, P≤0.030%, S≤0.030%, Cr 0.18%, Mo 0.12%, V 0.027%, Ni 0.26%, Cu 0.13%, Si 0.27%, Al 0.032%, Co 0.01%, Nb 0.02%, Sn 0.01%, Zr 0.01%; with a CE value (as defined herein) of ˜0.4%. For example, such a composition may have the following proportions (in decreasing order): Fe (97.5%), Mn (1.08%), Si (0.27%), Ni (0.26%), Cr (0.18%), Cu (0.13%), Mo (0.12%), C (0.087%), Al (0.032%), V (0.027%), Nb (0.02%), Co (0.01%), Zr (0.01%), Sn (0.01%), P (0.008%), S (0.003%), Ti (0.003%), other/margin of error (0.25% of total mass). The pipeline 22 and pipe sections 28 being welded to it are of the same material.

The processes associated with the laying of the pipeline are divided across several working stations 30, 32, equi-spaced with respect to the conventional joint length and included within the string production line (firing line). In this case, a first working station is in the form of a pipe coupling station 30, at which a new section 28 of pipe is welded to the free end of the pipeline 22. A second working station is in the form of a non-destructive testing (NDT) station 32, at which the quality of the weld joint is tested. Tensioners 34 hold the pipeline 22 under tension.

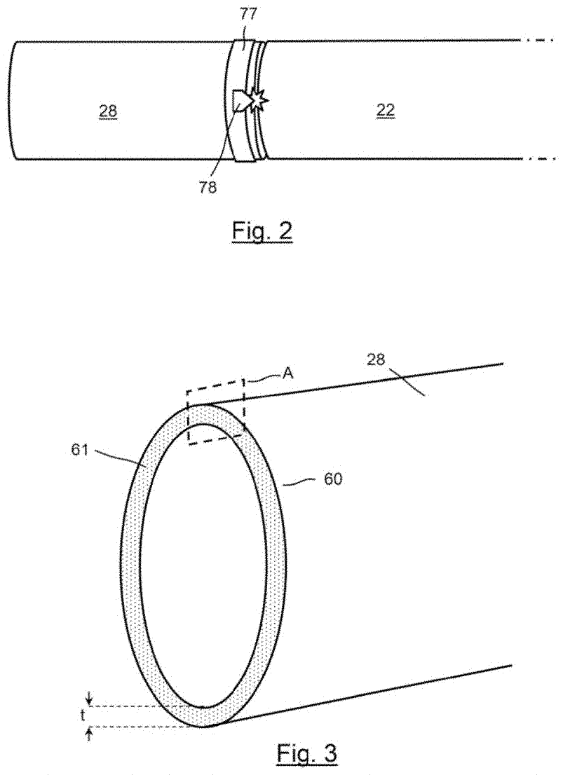

It is desirable to improve the speed at which sections 28 of pipe can be welded onto the pipeline 22, as this can be the principal limitation on the rate at which pipeline can be laid from the vessel. In this embodiment, the weld joint is quickly and efficiently performed in one welding-pass with the use of a laser welding apparatus, as shown in more detail in FIGS. 2 to 4.

FIG. 2, shows a welding bug 78, incorporating a laser-based welding torch, travelling in a circumferential direction around the joint to be formed between a pipe section 28 and the end of the pipeline 22 (“the pipes”). The welding bug 78 is attached and guided by a welding belt 77, which is clamped to one of the pipes 22, 28. The ends of the pipes are prepared before welding by means of a method carried out at a location different from the pipe coupling station 30, as will now be described with reference to FIG. 3.

FIG. 3 shows an end 60 of a pipe 28 on which there has been deposited a layer 61 of filler material. The filler material of layer 61 is made of a different material than the pipes 22, 28, has a higher Nickel content in particular. In this embodiment, the material of layer 61 has an alloying composition as follows: Fe (95.8%), Mn (1.1%), Si (0.6%), Ni (2.4%), and C (0.1%).

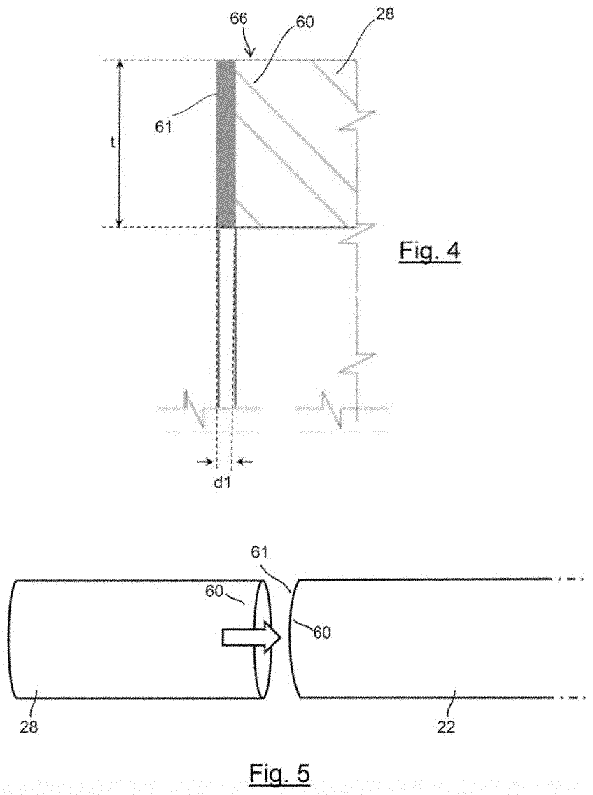

In the first embodiment of the invention, the layer 61 is applied and coated on the ends of the pipes (both ends of all pipe sections 28) to be welded, long before the welding process begins, for example at a location on-shore, before the pipes are loaded onto the vessel. The material 61 is deposited on the end of the pipe across the entire cross-sectional area of the end 60 of the pipe, as shown in FIGS. 3 and 4. FIG. 4 is a partial cross section of the pipe representing the area marked by the box A shown in FIG. 3. The axis of the pipe is horizontal in FIG. 4, and an exterior surface 66 of the pipe is shown at the top of the FIG. 4. The depth (thickness, d1) of the layer 61 (as measured in the direction parallel to the axis of the pipes) is ˜0.3 mm on each pipe end. Each pipe has a wall thickness, t, of ˜30 mm.

The relatively thin depth of the layer 61 allows for a quick deposition of the material on the pipe end during preparation, and also results in a welded joint which comprises both the base pipe material and the material deposited 61. In this first embodiment of the invention, the intermediate material 61 is deposited on the ends of the pipes 60 by means of cold spray deposition, on land in a factory.

FIG. 5 shown the pipe 28 with its coated end 60 being moved towards the end 60 of the pipeline 22, which is also coated. Thus, the pipe pieces 22 and 28 are brought together, so that their ends 60 touch. Each end face of the pipes will have imperfections so that the surfaces deviate from the desired result of having two perfectly flat and parallel end faces. The pipes are urged together with sufficient force that some of the material 61 on the ends of the pipes deforms, effectively being squeezed from regions on the opposing end faces that are closer together to regions on the opposing end faces that are further apart. Thus, some of the material 61 moves to reduce the size of cavities or gaps that would otherwise exist without such material deformation.

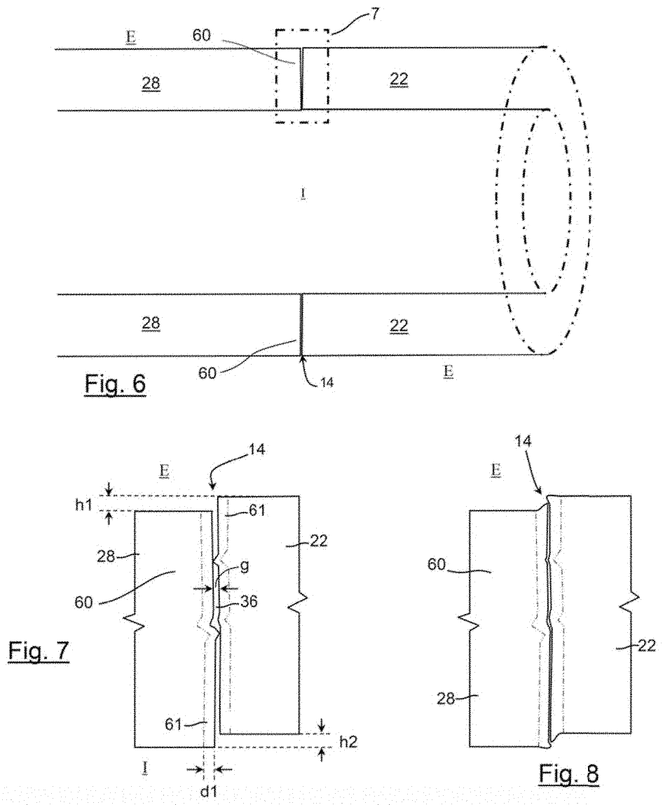

FIG. 6 shows a partial cross section view of the pipes 22, 28 having been brought into contact with each other and approximately aligned but before the third material has deformed. The pipes 22, 28 are arranged end-to-end, with the exterior (outside) of the pipe being denoted by the reference “E” and the interior (inside) of the pipe being denoted by the reference “I”. The ends of pipes have been machined flat and coated with filler material 61. A joint 14 to be welded is defined between the ends of the sections of pipe. FIG. 7 is an enlarged view of the portion labelled as 7 in FIG. 6. Thus, the exterior E of the pipe is uppermost in FIG. 7 and the interior I of the pipes is lowermost. The shapes of the end faces of the pipes shown in FIG. 7 are distorted for the sake of illustrating misalignment of the pipes. One such measure of pipe alignment, at a given location on the joint to be welded, is the “high-low value” (or just “hi-lo”). The hi-lo is the distance, in the radial direction, between two corresponding positions on two adjacent pipe end-faces. FIG. 7 shows two measures of external misalignment in the radial direction: a step of depth h1 between the outside diameters of the pipe ends (the “external cap hi-lo”) and a step of depth h2 between the inside diameters of the pipe ends (the “internal hi-lo”). The values of hi-lo h1 and h2 may vary around the circumference of the pipes. This may be due to misalignment of the pipes' axes and/or deviations of the pipes' perimeters from a circular shape (“Out Of Roundness” which may sometimes be abbreviated to “OOR”).

Furthermore, a gap or cavity may exist between the end faces of the sections of pipe prior to welding. The “gap” (see for example the gap labelled g in FIG. 7) may be defined as the distance between two pipe end faces in a direction approximately parallel to the axes of the sections of pipe. The gap may vary around the joint to be welded in both the radial distance from the pipes' axes and around the circumference of the pipes' end faces. It will be appreciated that a gap of zero will indicate that the sections of pipe are touching at that point. FIG. 7 shows the gap and a corresponding cavity 36 at the time at which the layers 61 have first touched.

In this embodiment, the intermediate material 61 is engineered to have a lower hardness and/or stiffness than the material used to make the pipe. Further movement of the pipes towards each other thus deforms the layers 61, as shown in FIG. 8. (The pipes 22 and 28 are brought together with sufficient force so that the intermediate material 61 deforms). The cavity 36 of FIG. 7 is now filled with material 61, or viewed another way, the cavity 36 no longer exists. It may also be the case that the intermediate layer deforms at the outer and inner diameter of the pipe so as to reduce the internal hi-lo and the external hi-lo, immediately before welding. Thus, in this embodiment, the material 61 deforms in such a way as to reduce the effect of gaps between the ends 60 of the pipes and to reduce the effect of radial off-sets (hi-lo parameters h1, h2).

On welding of the pipes together all of the intermediate layer 61 melts and forms part of the weld joint. With reference again to FIG. 2, the welding apparatus used incorporates a laser source which performs a keyhole welding of the full thickness of the pipes as it travels around the joint in a circumferential direction. The spot size of the laser may have a diameter of about 400 μm delivering heat energy at a density of about 70 kW/mm².

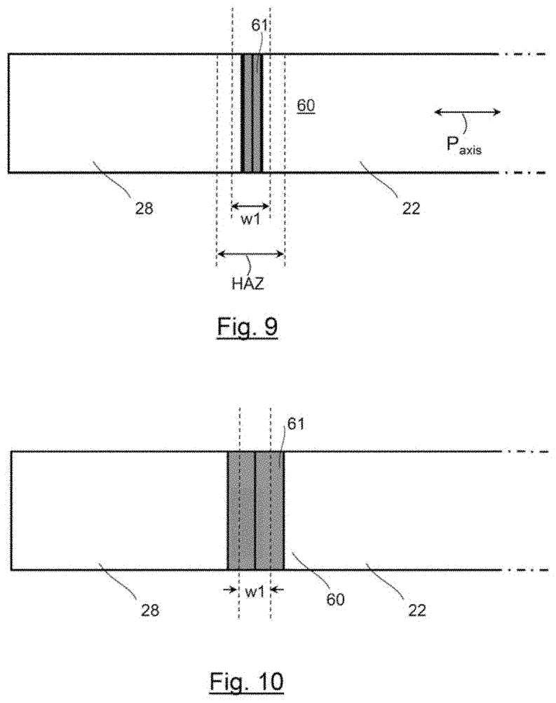

FIG. 9 shows a side view of the pipes once welded together, with the size of the intermediate layers 61 before welding being overlaid, showing schematically their thickness as measured in the direction parallel to the axis Pₐₓᵢₛ of the pipe. The thickness of the weld seam w1 (being ˜3 mm) is sufficiently large that it encompasses all of the intermediate material (the two layers 61 having a combined thickness of ˜0.6 mm) and a portion of the material of each pipe 22, 28. The thickness of the heat affected zone is of course greater than the thickness of the weld seam, as is shown schematically in FIG. 9 by the double-headed arrow labelled HAZ. Mixing of the base pipe material and the intermediate material occurs during welding. The composition of the welded material can be controlled as a result of the relatively even distribution of filler material 61 and the consistent welding process used. The weld joint may have a composition such that the components in the weld itself are as follows: Fe (97.16%), Mn (1.084%), Si (0.336%), Ni (0.688%), Cr (0.144%), Cu (0.104%), Mo (0.096%), C (0.0896%), Al (%), V (0.0216%), Nb (0.016%), Co (%), Zr (%), Sn (%), P (0.0064%), S (0.0024%), Ti (0.0024%). The material structure of the weld is such that the crystallographic grains which form in the material when subjected to a high cooling rate grow in such a way that the likelihood for crack formation in the material is reduced in comparison to the likelihood of crack formation occurring in the pipe material when the same cooling rate is applied.

In this first embodiment of the invention, the properties of the intermediate material 61 are tailored for the purpose of welding, and the steel material is similar in make-up to the base material of the pipes. The intermediate material has a melting point which correlates well with the incident energy from the welding source.

The laser welding method of the first embodiment has many advantages. It is quick and efficient and enables faster production in the firing line. The weld joint has a composition that is consistent across the full depth of the weld. It works well with welding thick pipes, with a thickness of, say, greater than 20 mm. The method represents a way of efficiently forming quality welds with a one-pass laser welding method. The problems typically associated with rapid cooling of weld material that has been heated to the very high temperatures associated with deep full penetration laser welding are mitigated. The problems typically associated with misalignment of pipes ends, for example relatively hi-lo values and/or gaps between the pipes, can be mitigated by means of the deformable filler material.

FIG. 10 illustrates, by way of a contrast, a method of joining pipes, similar to that of the first embodiment of the invention, except that a super abundant thickness of filler material 61 is used, which results in a weld joint whereby the only material in the weld joint that is melted during the laser welding process is the deposited material 61. The fact that the weld joint comprises only one material may have the benefit that the material composition is better defined, and allows for the tailoring of the material properties to be optimum for welding at the point where the welding takes place. This could also improve the quality of weld, as the weld-ability of the steel usually used in the construction of pipelines can sometimes be poor. FIG. 10 shows the relative thickness of the weld seam w1 where the intermediate material 61 is applied, before welding, superabundantly. In this case, intermediate material 61 is applied by means of a prior hot deposition process (using an arc welding process) which melts the surface of the base material during application, with a slow cooling process, to allow a strong junction between the intermediate material 61 and the base material of the pipe. This deposition process may be known as “buttering” in the art. (The general concept of “buttering” of work piece surfaces in this manner before forming a joint between the work pieces is known in the prior art.) The deposition process could be performed in a purpose built prefabrication line on the pipe laying vessel. The intermediate material used in this example is an alloy of steel containing manganese, silicon and a high percentage by weight of nickel. Other elements included in non-negligible quantities the intermediate material in this example of the invention include chromium, molybdenum, vanadium, copper, titanium and niobium. In this illustrated example, the thickness of the material used to coat the pipes is applied on the end edges of both of the pipes at a thickness of 3 mm, so the total thickness of the intermediate material is 6 mm. The use of the material in a super abundant manner allows for the most control of the chemical properties of the weld joint. In this example, the pipes that are welded together have a thickness of 35 mm, and a tube outer diameter (of the steel pipe) of 120 cm. Aspects of this example are included in the present disclosure as they may be combined with features of other embodiments of the invention.

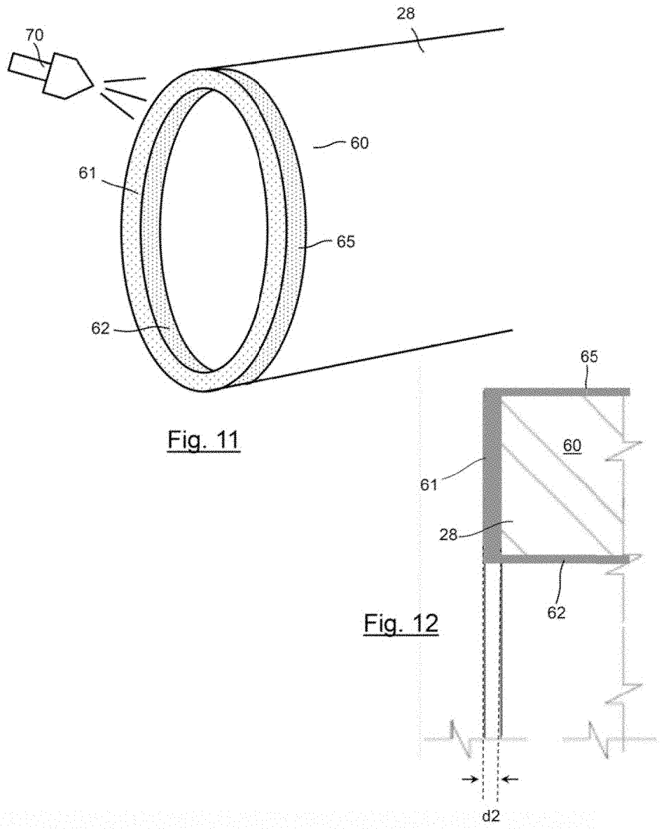

A second embodiment of the invention relates solely to the preparation of the pipes, by depositing material on a pipe end to form an integrated filler layer on the end of the pipe. The second embodiment is illustrated with reference to FIG. 11. The method of the second embodiment of the invention may be used to prepare pipes to be used as the pipes of the first embodiment or of the example of FIG. 10. FIG. 11 shows a different way of depositing material on the pipe end, however. FIG. 11 shows both intermediate 61 applied as a covering on the end face of the pipe 28 but the coating also extends along the inside (coating layer 62) and the outside surface of the pipe (coating layer 65). This ensures that there is still sufficient filler material when the intermediate material melts during welding and the material in the region between the two pipes effectively shrinks. In this embodiment, the outer diameter of the filler material is greater than the outer diameter of the pipe, before welding, but after welding the joint between the two pipes may have an outer diameter which is substantially the same as the outer diameter of the pipes. FIG. 11 shows a filler layer deposition device in the form of a spray gun 70, which is spraying, in a controlled manner, filler material onto the end of the pipe 28. In this embodiment of the invention, the hardness of the intermediate material is at least an order of magnitude lower than the hardness of the pipe material, which in this embodiment of the invention is 300HV10. FIG. 12 shows a section of the end of the pipe in cross-section and can be compared and contrasted with FIG. 4 showing a similar view of the pipe of the first embodiment. According to this second embodiment, the thickness (d2) of the deposited material is ˜0.1 mm on each end of the pipe, and about 80 μm on each of the outer and inner surfaces. The total thickness of the intermediate material when the pipe ends are brought together is thus ˜0.2 mm.

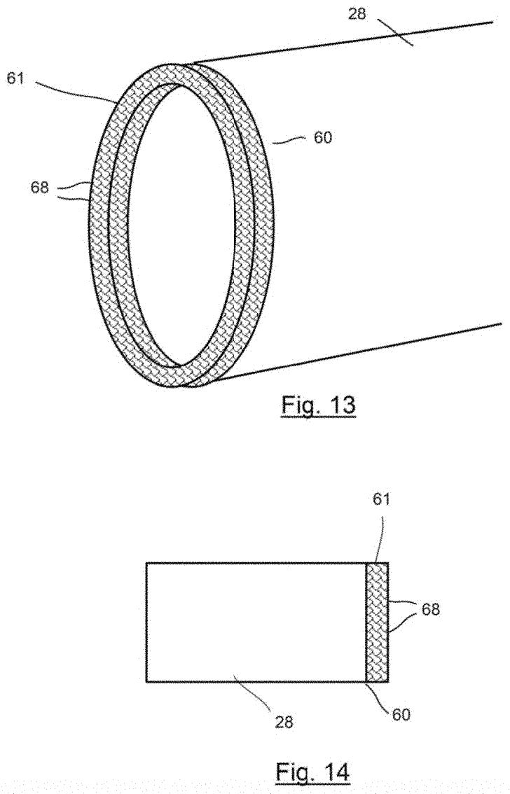

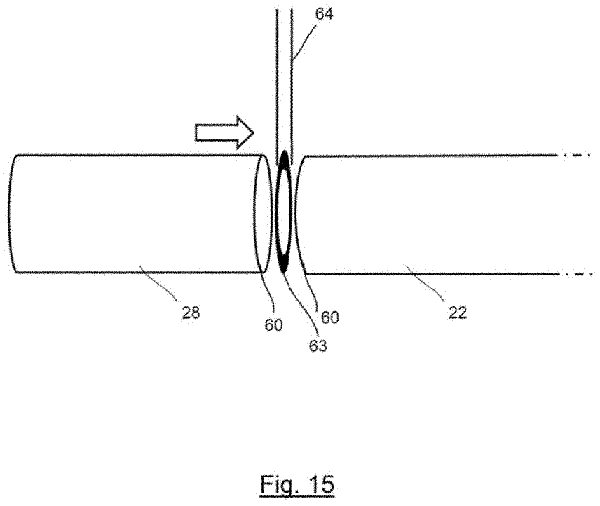

A third embodiment of the invention is illustrated by FIGS. 13 and 14. In this embodiment, the intermediate material 61 is deposited on the ends 60 of the pipes as a porous material having multiple voids formed therein. Such voids may comprise at least some that are in fluid communication with each other. Such voids may comprise at least some that are closed voids. In this embodiment of the invention, the coating of the pipes performed in a factory on land. The intermediate material 61 is deposited as a lattice-type material having voids 68 that collapse as the surrounding material deforms when the pipe ends are brought together. Such voids 68 are evenly distributed to ensure an even distribution of the filler material between the faces of the ends 60 of the pipes when fully brought together. This may assist in accommodating for misalignment in the axial and radial direction of the pipe end faces. Each of the voids may have a volume of between 0.001 mm³ and 1 mm³. There may therefore be thousands of such voids distributed within the layers of material deposited on each end face of each pipe. The material may be deposited on the pipe ends using an additive manufacturing technique, for example using a laser metal deposition technique.

FIG. 15 illustrated a fourth embodiment of the invention, which incorporates the features of previous embodiments, except that the intermediate material is not coated on either of the ends 60 of the pipes. Instead, it is provided as a thin layered gasket 63 which in use is inserted between the pipes, mechanically by a device 64, as the two pipes are brought together. This has the benefit that the pipes do not have to be pre-coated before welding. The gasket 63 is made of material that is softer than the pipe material and is thus able to deform in the manner described above to reduce the effects of misalignment of the pipe end faces.

A fifth embodiment of the invention, not separately illustrated, incorporates the features of the first embodiment, except that the intermediate material is substantially entirely nickel (purity >99%), and is applied at a minimal thickness, 0.1 mm on one pipe end face only meaning that the total thickness of filler material sandwiched between the pipe end faces is 0.1 mm. The weld seam has a thickness of 5 mm. The base material of the pipes has the following (non-exhaustive list of) constituents: Fe (97.5%), Mn (1.08%), Si (0.27%), Ni (0.26%), Cr (0.18%), Cu (0.13%), Mo (0.12%), and C (0.087%). The resultant weld seam comprises a steel containing a higher weight percentage of nickel, which gives improved resistance to solidification cracking in comparison to a join made out of only the base material. The weld once formed has reduced amounts of at least Fe (95.5%) and Mn (1.06%) and an increased Ni content (2.25%). Use of a minimum thickness of filler material allows for speedy deposition of the material during manufacturing, and results in a weld join which comprises both the base pipe material and the material deposited.

A sixth embodiment of the invention, not separately illustrated, is similar to the first embodiment apart from the differences that are now described. The layer applied to both pipe ends is a steel alloy having about 65-70% by weight iron and deposited at a thickness of the order of about 50 microns. Suitable alloys include FeMn (which includes about 35% Manganese), AISI 304 (which includes about 18% Chromium and 10% Nickel) and Invar (which includes about 36% Nickel). The layer has a hardness that is harder than the base material. When the pipes are forced together, the steel pipe material may deform more than the layer of intermediate material. Despite the low volume of intermediate material provided having a different chemical composition from the pipe steel, there are, perhaps surprisingly, sufficient levels of non-iron metal to improve the quality of the weld caused by the subsequent laser welding.

Whilst the present invention has been described and illustrated with reference to particular embodiments, it will be appreciated by those of ordinary skill in the art that the invention lends itself to many different variations not specifically illustrated herein. By way of example only, certain possible variations will now be described.

The filler material (intermediate material) may be a steel alloy of chromium, molybdenum, and vanadium. These materials are particularly resistant to long term plastic deformation (known as creep), so make a good choice as an intermediate material for a pipeline as they rest the long-term undesirable effects of heating and cooling cycles in the pipe.

The additive manufacturing technique described above could be an electron beam melting deposition.

The filler material may include aluminium and/or silicon in its composition. Such additions may act as deoxidising agents as the weld forms, reducing the presence of oxygen in the melt as the metal solidifies. This may in turn lower the number and/or size of voids and/or pores in the welded joint, which might otherwise weaken its mechanical properties.

The filler material may be made of manganese carbon steel. Manganese carbon steel is particularly resistant to solidification cracking, as well as being very resistant to abrasion, so makes a good choice of material for an intermediate material of use in the welding of pipes.

The composition of the filler material (intermediate material) may be tailored to be resistant to the corrosive effects that often occur in joints of welded pipes that are required to carry “sour” services (oil/gas products having a high Hydrogen Sulphide content—H₂S). This may be achieved by reducing the hardenability (i.e. ensuring that the joint formed has a low carbon content (or low CE value)—for example, lower than the alloy from which the steel pipes are made. Alternatively, or additionally, the S content and/or P content may be reduced. The Nickel content of the weld joint may need to be kept below 1% for sour service pipelines. The corrosive effects to be mitigated against may be the “inclusion” of sulphur based compounds, from the so-called sour services, into the microstructure of the material, causing weaker mechanical properties, and cracking.

In may be that the intermediate material is held in place by a spacer arrangement, as described in WO2017140805. The welding apparatus may be as described and claimed in WO2017140805. The contents of that application are fully incorporated herein by reference. The claims of the present application may incorporate any of the features disclosed in that patent application. In particular, the claims of the present application may be amended to include features relating to the laser beam welding equipment of WO2017140805 and/or the induction heating method employed.

The chemical composition of the filler material may be engineered to reduce the effect of impurities by adding into the filler material alloying elements, such as for example manganese and/or silicon, which induce grain toughness or refinement.

The filler material when porous/comprising voids may comprise, at least in part, an open cell solid foam. The material may comprise, at least in part, a closed cell solid foam.

Voids and/or pores may comprise about 5% of the sum volume of the filler material (that sum volume including both the volume of the solid material and the volume of the gaps defined by the voids/pores, at the stage immediately before any deformation of the filler material).

As an alternative to forming the intermediate material as a void-containing porous structure (as shown in FIGS. 13 and 14) so that the material has macroscopic properties facilitating deformation of the material when the pipe ends are brought together, other structures could be deposited having similar macroscopic material properties. For example, the intermediate material could be laid down as an array of multiple discrete structures that are readily deformable when the pipe ends are brought together. Such structures may crush and/or readily deform as the pipes are brought together, to ensure an even distribution of the filler material between the faces of the ends of the pipes. Such structures could have an irregular shape and form what might be described as a dendritic pattern. The structures may be similarly sized in cross-sectional shape but may have varying heights (as measured in the direction of the pipe axis). The structures may each have a cross-section being no more than about 1 mm² in area. There may therefore be thousands of such structures distributed across each end face of each pipe. Such structures could take various shapes, and be distributed and arranged in various ways. For example, the array of structures may appear as a bed of needles. The array of structures may look like a distribution of hairs. The structures may be take the form of a distribution of columns, which protrude at different distances and angles from the pipe end face. A reticular pattern of structures is also possible. Such structures may be deposited on the pipe ends using an additive manufacturing technique.

While the filler material is in many embodiments expected to be deposited on the entirety of the end face of a pipe, and be present along the whole circumference of the face and across the full thickness of the pipe, it will be appreciated that there may be small areas, and/or negligible gaps, on the end face not being covered by the deposited material. This may be the case in particular where the material is deposited as a distribution of many small structures across the surface of the end face.

It is understood that the intermediate material, as shown in FIG. 15, could be held in between the pipes in ways other than by using the mechanical apparatus described. For example, clamps, or chemical adhesive, may be used to hold the intermediate material in place.

The pipes may be coated with other materials such as concrete and/or plastic coverings, before and/or after welding.

The welding steps may be performed in separate stages at separate welding stations. There may be multiples welding passes performed at a single weld station. Multiple welding torches may be used at a single weld station. There may be multiple welding heads.

There may be application in relation to other types of welding, not being girth welding of pipes, as shown in the drawings.

Where in the foregoing description, integers or elements are mentioned which have known, obvious or foreseeable equivalents, then such equivalents are herein incorporated as if individually set forth. Reference should be made to the claims for determining the true scope of the present invention, which should be construed so as to encompass any such equivalents. It will also be appreciated by the reader that integers or features of the invention that are described as preferable, advantageous, convenient or the like are optional and do not limit the scope of the independent claims. Moreover, it is to be understood that such optional integers or features, whilst of possible benefit in some embodiments of the invention, may not be desirable, and may therefore be absent, in other embodiments.

1-19. (canceled)

20. A method of welding a first pipe and a second pipe end-to-end to form at least part of a pipeline that is suitable for use for conveying oil and/or gas, wherein
the first pipe is made from a first metal material and the second pipe is made of a second metal material, the first pipe and the second pipe each having an end face, at least one of the end faces of the pipes having deposited thereon a layer of a third material having a chemical composition which is different from that of the first material and the second material, the layer having a thickness of 1 mm or less,
and the method comprises the following steps:
bringing the end face of the first pipe and the end face of the second pipe together with the third material forming an intermediate layer of material positioned between the end faces of the pipes, thus forming a joint to be welded;
subsequently providing heating energy to the joint to be welded, thereby melting the intermediate layer of material and at least part of the first material and at least part of the second material;
thereafter removing said heating energy; and
allowing the heated material to solidify, so that a joint is made between the two pipes comprising a weld seam which has a thickness which is greater than the thickness of the intermediate layer of material.

21. A method according to claim 20, wherein the thickness of the layer of third material deposited on the end face of one of the pipes is less than or equal to 0.2 mm.

22. A method according to claim 20, wherein the thickness of the layer of third material deposited on the end face of one of the pipes is of the order of 10s of microns.

23. A method according to claim 20, wherein the third material is an alloy containing greater than 5% by weight Nickel and/or greater than 10% Manganese and/or the third material is an iron and/or steel alloy.

24. A method according to claim 20, wherein the bringing the end face of the first pipe and the end face of the second pipe together and the making of the joint between the two pipes occur at a single welding workstation.

25. A method according to claim 20, wherein the step of providing heating energy to the joint to be welded is performed by keyhole welding with a laser welding device.

26. A method according to claim 20, wherein the end face of the pipe has an annular shape and the overall shape of the intermediate layer of material between the end faces of the pipes corresponds to that of the end face of the pipe.

27. A method according to claim 20, wherein the first and second pipes each have an outer diameter greater than 150 mm and a pipe wall thickness of greater than 15 mm.

28. A method according to claim 20, wherein the step of providing heating energy to the joint is performed as a one-pass welding process with a welding apparatus to form a weld between the pipes having a depth of more than half of the thickness of the pipes.

29. A method according to claim 20, wherein the method includes a step of depositing the intermediate layer of material on at least one of the end faces of the pipes before the step of bringing the end faces of the pipes together.

30. A method according to claim 20, where the intermediate layer is deposited by means of an additive manufacturing technique.

31. A method according to claim 20, where the method is performed on a pipe-laying vessel at sea.

32. A pipe with an integrated layer of material on at least one end face of the pipe, the pipe and the integrated layer of material being configured for use as the first pipe and the intermediate layer of material as claimed in the method according to claim 20.

33. A method of depositing material on an end of a pipe so as to form a pipe according to claim 32 or a first pipe and intermediate layer of material,
wherein the first pipe is made from a first metal material and the second pipe is made of a second metal material, the first pipe and the second pipe each having an end face, at least one of the end faces of the pipes having deposited thereon a layer of a third material having a chemical composition which is different from that of the first material and the second material, the layer having a thickness of 1 mm or less,
and the method comprises the following steps:
bringing the end face of the first pipe and the end face of the second pipe together with the third material forming the intermediate layer of material positioned between the end faces of the pipes, thus forming a joint to be welded;
subsequently providing heating energy to the joint to be welded, thereby melting the intermediate layer of material and at least part of the first material and at least part of the second material;
thereafter removing said heating energy; and
allowing the heated material to solidify, so that a joint is made between the two pipes comprising a weld seam which has a thickness which is greater than the thickness of the intermediate layer of material.

34. A method according to claim 33, where the material is deposited by means of a laser metal deposition additive manufacturing technique.

35. A kit of parts for laying a pipeline, the kit comprising multiple pipes, each being a pipe according to claim 32, and a welding apparatus for providing the heating energy required to perform the method of welding a first pipe and a second pipe end-to-end to form at least part of a pipeline that is suitable for use for conveying oil and/or gas, wherein
the first pipe is made from a first metal material and the second pipe is made of a second metal material, the first pipe and the second pipe each having an end face, at least one of the end faces of the pipes having deposited thereon a layer of a third material having a chemical composition which is different from that of the first material and the second material, the layer having a thickness of 1 mm or less,
and the method comprises the following steps:
bringing the end face of the first pipe and the end face of the second pipe together with the third material forming an intermediate layer of material positioned between the end faces of the pipes, thus forming a joint to be welded;
subsequently providing heating energy to the joint to be welded, thereby melting the intermediate layer of material and at least part of the first material and at least part of the second material;
thereafter removing said heating energy; and
allowing the heated material to solidify, so that a joint is made between the two pipes comprising a weld seam which has a thickness which is greater than the thickness of the intermediate layer of material.

36. A kit of parts for laying a pipeline, the kit comprising
multiple pipes, and
apparatus configured to perform the method of claim 33, and
a laser welding apparatus for providing the heating energy required to perform the method of welding a first pipe and a second pipe end-to-end to form at least part of a pipeline that is suitable for use for conveying oil and/or gas, wherein
the first pipe is made from a first metal material and the second pipe is made of a second metal material, the first pipe and the second pipe each having an end face, at least one of the end faces of the pipes having deposited thereon a layer of a third material having a chemical composition which is different from that of the first material and the second material, the layer having a thickness of 1 mm or less,
and the method comprises the following steps:
bringing the end face of the first pipe and the end face of the second pipe together with the third material forming an intermediate layer of material positioned between the end faces of the pipes, thus forming a joint to be welded;
subsequently providing heating energy to the joint to be welded, thereby melting the intermediate layer of material and at least part of the first material and at least part of the second material;
thereafter removing said heating energy; and
allowing the heated material to solidify, so that a joint is made between the two pipes comprising a weld seam which has a thickness which is greater than the thickness of the intermediate layer of material.

37. A pipe-laying vessel including a kit of parts according to claim 35.

38. A method of laser welding a first pipe and a second pipe end-to-end to form at least part of an oil/gas pipeline, wherein
the first pipe is made from a first metal material and the second pipe is made of a second metal material,
the first pipe and the second pipe each having an end face,
at least one of the end faces of the pipes has deposited thereon a layer of a third material having a chemical composition which is different from that of the first material and the second material, and
the thickness of the layer of third material deposited on the end face of one of the pipes is less than or equal to 0.2 mm,
and the method comprises the following steps:
bringing the end face of the first pipe and the end face of the second pipe together, such that the third material, having previously been deposited on at least one of the end faces of the first pipe and the second pipe, forms an intermediate layer of material positioned between the end faces of the pipes, thus forming a joint to be welded; and
subsequently welding the pipes together with a keyhole laser welding process, which melts the intermediate layer of material and at least part of the first material and at least part of the second material;
thus forming a joint between the two pipes comprising a weld seam which has a thickness which is greater than the thickness of the intermediate layer of material.

39. A method according to claim 38, wherein the first and second pipes each have an outer diameter greater than 150 mm and a pipe wall thickness greater than 15 mm,

40. A method according to claim 38, wherein the thickness of the layer of third material deposited on the end face of one of the pipes is of the order of 10s of microns.
